(19) United States
(12) Patent Application Publication
(10) Pub. No.: US 2025/0299237 A1
(43) Pub. Date: Sep. 25, 2025

(54) SEARCHING AND EXPLORING DATA PRODUCTS BY POPULARITY

(71) Applicant: INTERNATIONAL BUSINESS MACHINES CORPORATION, Armonk, NY (US)

(72) Inventors: Balaji Ganesan, Bengaluru (IN); Rajmohan Chandrahasan, Kanchipuram district (IN); Ritwik Chaudhuri, Bangalore (IN); Arvind Agarwal, New Delhi (IN)

(21) Appl. No.: 18/614,992

(22) Filed: Mar. 25, 2024

(51) Int. Cl. G06Q 30/0601; G06N 5/02

(52) U.S. Cl. CPC G06Q 30/0625; G06N 5/02; G06Q 30/0631

(57) ABSTRACT

A computer-implemented method may include identifying an entity in a user query or a user profile; mapping, via a relational graph convolutional network model, the entity to a knowledge node in a knowledge graph; mapping, via a semantic relevance learning engine, the knowledge node of the knowledge graph to a lineage node of a lineage graph; generating a list of matched nodes from the mapping of the knowledge node of the knowledge graph to the lineage node of the lineage graph; generating a interestingness score for a dataset associated with the list of matched nodes; identifying a ranked dataset recommendation based on the interestingness score; and communicating instructions to communicate the interestingness score and the ranked dataset recommendation in a user interface.

### BACKGROUND

Aspects of the present invention relate generally to semantic searching and search result recommendations.

Semantic searching is a search engine capability used to provide search results based on the intent or meaning behind a search, such as searching for data products through an internet-based search engine. Semantic searching produces search results based on the meaning of a search query by interpreting words and phrases based on their contextual relevance. When a search query is submitted to a search engine, the search engine may transform the query into numerical representations of data and corresponding related context, which may be stored in query vectors. A semantic search engine may include an algorithm, such as a k-nearest neighbor (KNN) algorithm, which may match the vectors of existing documentation to the query vectors. A semantic search engine may then generate search results and rank them based on conceptual relevance.

### SUMMARY

In a first aspect of the invention, there is a computer-implemented method including: identifying an entity in a user query or a user profile; mapping, via a relational graph convolutional network model, the entity to a knowledge node in a knowledge graph; mapping, via a semantic relevance learning engine, the knowledge node of the knowledge graph to a lineage node of a lineage graph; generating a list of matched nodes from the mapping of the knowledge node of the knowledge graph to the lineage node of the lineage graph; generating a interestingness score for a dataset associated with the list of matched nodes; identifying a ranked dataset recommendation based on the interestingness score; and communicating instructions to communicate the interestingness score and the ranked dataset recommendation in a user interface.

In another aspect of the invention, there is a computer program product including one or more computer readable storage media having program instructions collectively stored on the one or more computer readable storage media. The program instructions are executable to: identify an entity in a user query or a user profile; map the entity to a knowledge node in a knowledge graph; map the knowledge node of the knowledge graph to a lineage node of a lineage graph; generate a list of matched nodes from the mapping of the knowledge node of the knowledge graph to the lineage node of the lineage graph; generate a interestingness score for a dataset associated with the list of matched nodes; identify a ranked dataset recommendation based on the interestingness score; and communicate instructions to communicate the interestingness score and the ranked dataset recommendation in a user interface.

In another aspect of the invention, there is a system including a processor set, one or more computer readable storage media, and program instructions collectively stored on the one or more computer readable storage media. The program instructions are executable to: identify an entity in a user query or a user profile; map the entity to a knowledge node in a knowledge graph; map the knowledge node of the knowledge graph to a lineage node of a lineage graph; generate a list of matched nodes from the mapping of the knowledge node of the knowledge graph to the lineage node of the lineage graph; generate a interestingness score for a dataset associated with the list of matched nodes; identify a ranked dataset recommendation based on the interestingness score; and communicate instructions to communicate the interestingness score and the ranked dataset recommendation in a user interface.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary system in accordance with aspects of the present invention.

FIG. 4A shows an exemplary user interface according to an embodiment of the present invention.

FIG. 4B shows an exemplary user interface according to an embodiment of the present invention.

FIG. 4C shows an exemplary user interface according to an embodiment of the present invention.

FIG. 5 shows an exemplary table according to an embodiment of the present invention.

FIG. 6 shows a block diagram of an exemplary environment in accordance with aspects of the present invention.

FIG. 7 shows a flowchart of an exemplary method in accordance with aspects of the present invention.

### DETAILED DESCRIPTION

Aspects of the present invention relate generally to semantic searching and, more particularly, to refined semantic searching and search result and dataset recommendations. According to aspects of the invention, the system may include enterprise data catalog searching using semantic relevance learning between knowledge graph concepts and a user profile lineage graph. The system may include methods of creating a lineage graph from events in a data marketplace, mapping knowledge and lineage graphs via semantic relevance learning, and ranking datasets by popularity using an interestingness measure.

In a data marketplace, typical signals for search and recommendations are unreliable because of insufficient user traffic compared to a web-based search. A web-based search may include a user searching for information via a web-browser and the search may return thousands of relevant results due to the vast quantity of information available over the internet. A data marketplace search may include a user searching for information available within a specific platform wherein users may buy, sell, or exchange data. Data marketplaces commonly have data tailored for specific needs or purposes, rather than the vast quantity of information available over the internet in a web-based search. A solution is needed to rank datasets, including results, by popularity metrics that go beyond conventional “likes,” reviews, views, downloads, etc., because such metrics are dependent on high traffic volume. The disclosed system provides a technical improvement, including refined semantic searching and search result and dataset recommendations configured to leverage metadata about datasets, user profiles, query intent, knowledge graphs, and lineage information from dataset creation and usage. The disclosed system provides a technical improvement by reducing the difficulties associated with “cold starts” or data sparsity in scenarios with low user counts and small data indexes.

According to embodiments, the system may include using Dirichlet-Hawkes Process (DHP) to accumulate logs and generate event entities in a data marketplace like dataset creation, updates, and model training. The system may generate a lineage graph combining the event entities and user entities who perform data operations in the data marketplace. During a search, the system may interpret user queries, identify the entities in the queries, and link them to concepts in a knowledge graph. In embodiments, the system may use user profiles if queries are absent. Using a relational graph convolutional network (RGCN) model trained on the lineage graph and the knowledge graph, the system may perform semantic relevance learning to generate a list of nodes from the lineage graph that are most relevant to the nodes in the knowledge graph. In this manner, the system may generate a static rank, i.e., an interestingness score, for the datasets associated with the lineage graph nodes. The system may define an interestingness measure, i.e., ranking datasets in the data marketplace with respect to relevance to the user query. The system may produce, communicate, or display a combination of static and dynamic scores i.e., semantic relevance score, produce dataset recommendations, and search results by popularity. In this manner, implementations of the invention improve the process of ranking and recommending search query results and datasets by popularity beyond simple metrics such as user “likes,” reviews, views, or downloads. In embodiments, the system may identify entities in a user query or user profile and map the entities to concepts in a knowledge graph via an RGCN model.

According to embodiments, the system may index popularity information relating to search results, including building a metadata search index including information about datasets, semantic concepts, and lineage information. Lineage information may include user information or user profile data from users who created or used datasets. A lineage graph may be generated via DHP based on the accumulated logs, such as user profile, user access details in a data marketplace, and a historical query, including clustering the user profile, user access details in a data marketplace, and historical queries. Lineage graphs may include concepts, including data products and users, as lineage nodes and edges. Similarly, knowledge graphs may include entities and their concepts as knowledge nodes and edges. A node may represent a corresponding object in a data source. An edge may represent a relation between nodes. Nodes and edges represent how data moves from a first data source to a second data source. DHP may cluster nodes representing user profiles, user access details in a data marketplace, and historical queries based on textual or temporal patterns observed in data. Clustering via DHP may include grouping similar data or documents into categories based on similarity. Clustering via DHP may include preprocessing of data within the user profile and the historical query including tokenization or feature extraction. Preprocessed data may be represented as numerical feature vectors which may be grouped based on similarity and may include, for example, a KNN algorithm. Clustering may include generating textual clusters having similar textual data, such as data related to similar topics, or temporal clusters having similar timing data, such as when data was modified. DHP may consider both the content and the time of interactions to cluster events having multiple users, which may or may not be linked based on the RGCN model. As an example, a lineage graph may be generated having nodes of clustered data indicating time-stamped events of when users edited documentation. In this way, user profiles may be linked to temporal events in a lineage graph.

According to embodiments, the system may identify entities in a user query or user profile and map the entities to concepts in a knowledge graph via an RGCN model. A knowledge graph may include linked descriptions of concepts, entities, events, and their corresponding relationships. An RGCN model may predictively link concepts, entities, events, and their corresponding relationships to generate the knowledge graph by classifying nodes based on concepts, entities, and events and identifying contextual relationships or inferences between nodes.

According to embodiments, the system may map lineage graph nodes to knowledge graph nodes via a semantic relevance learning engine by identifying similarities between nodes, such as text-based or temporal similarities. The system may make dataset recommendations, including ranking datasets, as search results, based on semantic relevance learning between concepts in the knowledge graph and user information in the lineage graph. As an example, the system may receive a search query and the system may output typical search results as well as ranked dataset recommendations as described herein. Recommendations may be dataset nodes that are linked nodes of both the knowledge graph and the lineage graph. According to embodiments, linked nodes may be ranked, such as by a semantic relevance score, indicative of the relative textual or temporal similarities or contextual relevance between two nodes on a lineage graph and a knowledge graph. An interestingness score may also be determined to quantify popularity based on the relevance of linked nodes to a user's profile, where a high interestingness score is indicative of overlap between the datasets of linked nodes and user profile data or historical query data. Recommendations may be ranked based on the semantic relevance score and the interestingness score.

According to embodiments, a computer-implemented method may include identifying an entity in a user query or a user profile; mapping, via a relational graph convolutional network model, the entity to a knowledge node in a knowledge graph; mapping, via a semantic relevance learning engine, the knowledge node of the knowledge graph to a lineage node of a lineage graph; generating a list of matched nodes from the mapping of the knowledge node of the knowledge graph to the lineage node of the lineage graph; generating a interestingness score for a dataset associated with the list of matched nodes; identifying a ranked dataset recommendation based on the interestingness score; and communicating instructions to communicate the interestingness score and the ranked dataset recommendation in a user interface. Aspects of the present invention improve the process of ranking and recommending search query results and datasets by popularity beyond metrics such as user “likes,” reviews, views, or downloads.

According to embodiments, a computer-implemented method may include generating the lineage graph based on the user profile, user access details in a marketplace, and a historical query. Aspects of the present invention improve the process of ranking and recommending search query results and datasets by popularity by mapping knowledge graphs and lineage graphs to identify relevant search results.

According to embodiments, a computer-implemented method may include generating the lineage graph including clustering the user profile and the historical query via Dirichlet-Hawkes processing (DHP). Aspects of the present invention improve the process of ranking and recommending search query results and datasets by popularity by improving the clustering of search result documentation.

According to embodiments, a computer-implemented method may include clustering including generating textual clusters, temporal clusters, or both. Aspects of the present invention improve the process of ranking and recommending search query results and datasets by popularity by improving the clustering of search result documentation while considering textual and temporal data.

According to embodiments, a computer-implemented method may include generating the lineage graph including clustering the user profile, the user access details in a data marketplace, and the historical query via DHP. Aspects of the present invention improve the process of ranking and recommending search query results and datasets by using contextual links between concepts to generate improved search query results.

According to embodiments, a computer-implemented method may include a semantic relevance learning engine configured to identify contextual links between the knowledge graph and the lineage graph. Aspects of the present invention improve the process of ranking and recommending search query results and datasets by using user profile and historical query data to generate improved user-relevant search query results.

According to embodiments, a computer-implemented method may include contextual links including knowledge graph nodes including user queries, and lineage graph nodes including user profiles. Aspects of the present invention improve the process of ranking and recommending search query results and datasets by interpreting user queries, such as via natural language processing, to improve search query results.

According to embodiments, a computer-implemented method may include contextual links including knowledge graph nodes including user query interpretation, and lineage graph nodes including users and datasets in a marketplace. Aspects of the present invention improve the process of ranking and recommending search query results and datasets by linking concepts within both the knowledge graph and the lineage graph.

According to embodiments, a computer-implemented method may include generating a semantic relevance score for the dataset associated with the list of matched nodes; identifying the ranked dataset recommendation based on the semantic relevance score; and communicating instructions to communicate the semantic relevance score and the ranked dataset recommendation in a user interface Aspects of the present invention improve the process of ranking and recommending search query results and datasets by providing, for example, a ranked listing of recommendations differing from standard search query results.

According to embodiments, a computer-implemented method may include generating the interestingness score is based on the user query and the mapping the knowledge node of the knowledge graph to a lineage node of a lineage graph. Aspects of the present invention improve the process of ranking and recommending search query results and datasets by providing a visual representation of recommendations differing from standard search query results.

According to embodiments, a computer program product comprising one or more computer readable storage media having program instructions collectively stored on the one or more computer readable storage media, the program instructions executable to: identify an entity in a user query or a user profile; map the entity to a knowledge node in a knowledge graph; map the knowledge node of the knowledge graph to a lineage node of a lineage graph; generate a list of matched nodes from the mapping of the knowledge node of the knowledge graph to the lineage node of the lineage graph; generate a interestingness score for a dataset associated with the list of matched nodes; identify a ranked dataset recommendation based on the interestingness score; and communicate instructions to communicate the interestingness score and the ranked dataset recommendation in a user interface. Aspects of the present invention improve the process of ranking and recommending search query results and datasets by popularity beyond metrics such as user “likes,” reviews, views, or downloads.

According to embodiments a computer program product is disclosed, wherein the program instructions are executable to: generate the lineage graph based on the user profile, user access details in a marketplace, and a historical query. Aspects of the present invention improve the process of ranking and recommending search query results and datasets by popularity by mapping knowledge graphs and lineage graphs to identify relevant search results.

According to embodiments a computer program product is disclosed, wherein the generating the lineage graph comprises clustering the user profile and the historical query via Dirichlet-Hawkes processing (DHP). Aspects of the present invention improve the process of ranking and recommending search query results and datasets by popularity by improving the clustering of search result documentation.

According to embodiments a computer program product is disclosed, wherein the clustering comprises generating textual clusters, temporal clusters, or both. Aspects of the present invention improve the process of ranking and recommending search query results and datasets by popularity by improving the clustering of search result documentation while considering textual and temporal data.

According to embodiments a computer program product is disclosed, wherein the generating the lineage graph comprises clustering the user profile, the user access details in a data marketplace, and the historical query via DHP. Aspects of the present invention improve the process of ranking and recommending search query results and datasets by using contextual links between concepts to generate improved search query results.

According to embodiments a computer program product is disclosed, wherein the contextual links comprise knowledge graph nodes including user queries, and lineage graph nodes including user profiles. Aspects of the present invention improve the process of ranking and recommending search query results and datasets by using user profile and historical query data to generate improved user-relevant search query results.

According to embodiments a computer program product is disclosed, wherein the contextual links comprise knowledge graph nodes including user query interpretation, and lineage graph nodes including users and datasets in a marketplace. Aspects of the present invention improve the process of ranking and recommending search query results and datasets by interpreting user queries, such as via natural language processing, to improve search query results.

According to embodiments a computer program product is disclosed, wherein the program instructions are executable to: generate a semantic relevance score for the dataset associated with the list of matched nodes; identify the ranked dataset recommendation based on the semantic relevance score; and communicate instructions to communicate the semantic relevance score and the ranked dataset recommendation in a user interface. Aspects of the present invention improve the process of ranking and recommending search query results and datasets by providing, for example, a ranked listing of recommendations differing from standard search query results.

According to embodiments a computer program product is disclosed, wherein the semantic relevance learning engine is configured to identify contextual links between the knowledge graph and the lineage graph. Aspects of the present invention improve the process of ranking and recommending search query results and datasets by providing a visual representation of recommendations differing from standard search query results.

According to embodiments a system is disclosed that may include a processor set, one or more computer readable storage media, and program instructions collectively stored on the one or more computer readable storage media, the program instructions executable to: identify an entity in a user query or a user profile; map the entity to a knowledge node in a knowledge graph; map the knowledge node of the knowledge graph to a lineage node of a lineage graph; generate a list of matched nodes from the mapping of the knowledge node of the knowledge graph to the lineage node of the lineage graph; generate a interestingness score for a dataset associated with the list of matched nodes; identify a ranked dataset recommendation based on the interestingness score; and communicate instructions to communicate the interestingness score and the ranked dataset recommendation in a user interface. Aspects of the present invention improve the process of ranking and recommending search query results and datasets by popularity beyond metrics such as user “likes,” reviews, views, or downloads.

Implementations of the invention are necessarily rooted in computer technology. For example, the steps of mapping, via a relational graph convolutional network model, an entity to a concept in a knowledge graph comprising a node; mapping, via a semantic relevance learning engine, the node of the knowledge graph to a lineage graph; and ranking, via the semantic relevance learning engine, a popularity of a search result corresponding to the user query based on the mapping of the node of the knowledge graph to the lineage graph are computer-based and cannot be performed in the human mind.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as popularity search code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

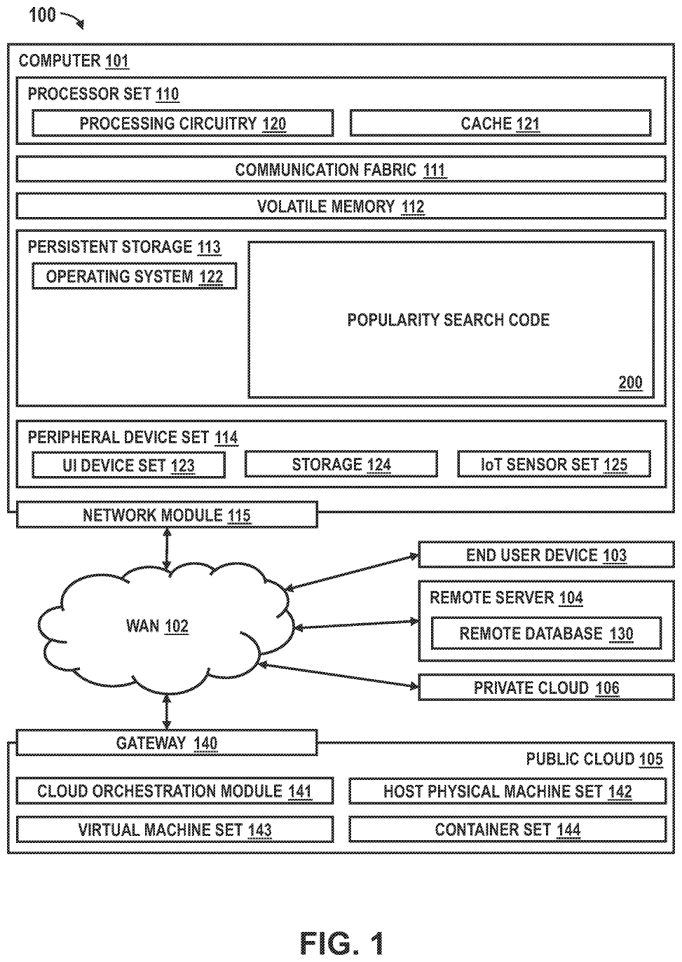

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

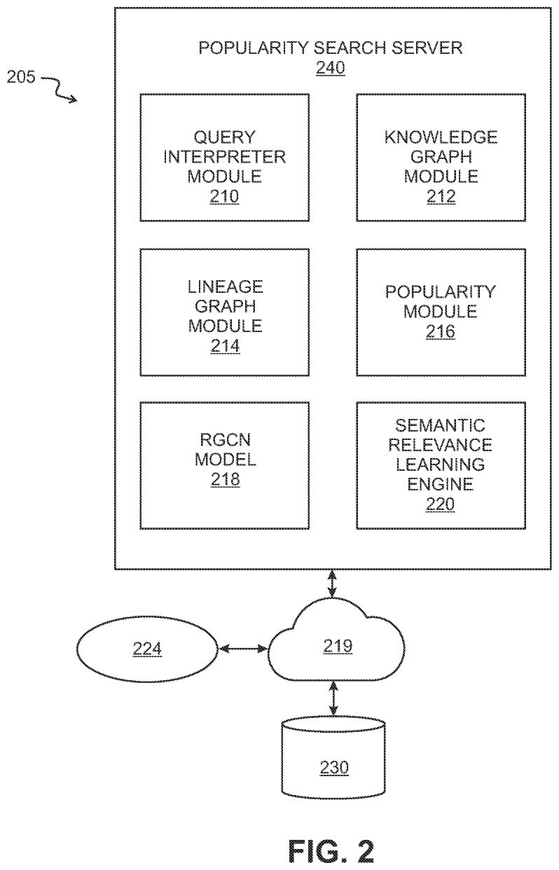

FIG. 2 shows a block diagram of an exemplary environment 205 in accordance with aspects of the invention. In embodiments, the environment includes popularity search server 240, corresponding to computer 101 of FIG. 1, including or in operable communication with query interpreter module 210, knowledge graph module 212, lineage graph module 214, popularity module 216, RGCN model 218, and semantic relevance learning engine 220, corresponding to semantic matching code of block 200, as in FIG. 1. The popularity search server 240 may be configured for: identifying an entity in a user query or a user profile; mapping, via a relational graph convolutional network model, the entity to a knowledge node in a knowledge graph; mapping, via a semantic relevance learning engine, the knowledge node of the knowledge graph to a lineage node of a lineage graph; generating a list of matched nodes from the mapping of the knowledge node of the knowledge graph to the lineage node of the lineage graph; generating an interestingness score for a dataset associated with the list of matched nodes; identifying a ranked dataset recommendation based on the interestingness score; and communicating instructions to display the interestingness score and the ranked dataset recommendation in a user interface. The environment 205 includes at least one database 230 in operable communication with the popularity search server 240 over network 219, corresponding to WAN 102 of FIG. 1. The database 230, corresponding to remote server 104 or remote database 130 of FIG. 1, may store data imported into the system. In embodiments, a user device 224 may be in operable communication with the popularity search server 240, such as when a user submits a search query to the popularity search server 240.

The query interpreter module 210 may be configured to identify entities in a user query or user profile. Entities may be objects stored in a database, such as a person, place, event, object, or event. Related data may be stored correlating to entities, such as entity types, temporal data, associated data, or metadata. For example, each of the words or phrases within a search query may be considered entities, alone or in combination. Entities may be identified as query concepts, such as people, places, events, things, or the like. Entities may be identified via, for example, natural language processing, data retrieval via a database management system, or querying the database management system based on specific criteria. In this manner, embodiments are configured to identify an entity in a user query or a user profile. A knowledge graph may include linked descriptions of concepts, entities, events, and their corresponding relationships. An RGCN model may predictively link concepts, entities, events, and their corresponding relationships to generate the knowledge graph by classifying nodes based on concepts, entities, and events and identifying contextual relationships or inferences between nodes.

The knowledge graph module 212 may be configured to adopt existing knowledge graphs based on user profiles or query data, or the system may interpret user queries, identify the entities in the queries, and link them to concepts in a knowledge graph. In embodiments, the system may use user profiles if queries are absent. Identifying entities may include categorizing query inputs such as words, terms, or phrases as data objects via semantic relevance learning, which may implement natural language processing to identify entities.

The lineage graph module 214 may be configured to generate a lineage graph combining event entities and user entities who perform data operations in the data marketplace. A lineage graph may be generated by profiling data with user profiles, a user access details in a marketplace, and a historical queries; tracing data through data sources and storage locations; and visualizing nodes representing a corresponding object in a data source and edges may representing a relation between nodes. A lineage graph may also be generated via DHP processing. A lineage graph may be generated based on the user profile, user access details in a data marketplace, and a historical query, including clustering the user profile, user access details in a data marketplace, and historical queries via DHP, including generating textual clusters, temporal clusters, or both. Clustering via DHP may include preprocessing of data within the user profile and the historical query including tokenization or feature extraction and grouping similar data or documents into categories based on similarity. Preprocessed data may be represented as numerical feature vectors which may be grouped based on similarity and may include, for example, a KNN algorithm, hierarchical clustering, density-based spatial clustering, etc. Clustering may include generating textual clusters having similar textual data, such as data related to similar topics, or temporal clusters having similar timing data, such as when data was modified. In this manner, embodiments are configured to generate the lineage graph comprising clustering the user profile, user access details in a data marketplace, and historical queries via DHP. The lineage graph module 214 may generate or identify nodes and edges within the graph corresponding to concepts and relationships between user profiles, user access details in a data marketplace, and a historical queries. In this manner, embodiments are configured to generate a lineage graph based on the user profile, a user access details in a marketplace, and a historical query.

The popularity module 216 may be configured to generate an interestingness score for datasets associated with the lineage graph nodes. Additionally, the popularity module 216 may be configured to classify nodes based on their relevance to a user query. Classifying nodes may be learned over time based on additional users and queries. The system may define an interestingness measure, i.e., ranking, for datasets in a data marketplace, with respect to a user query. For example, interestingness may be an interestingness score, i.e., reflecting the popularity of a document or dataset or a dynamic ranking, i.e., the semantic relevance of a document or dataset with respect to a user query. Interestingness may be measured as an interestingness score. The interestingness score may be generated based on the mapping of knowledge nodes from the knowledge graph that are mapped to with lineage nodes in the lineage graph based on semantic relevance determined via the semantic relevance learning engine 220. An interestingness score for matched nodes and their associated datasets may be determined via the semantic relevance learning engine 220. The semantic relevance learning engine 220 may identify similarities between nodes, such as text-based or temporal similarities, via feature extraction, measuring similarities between nodes, e.g., via cosine similarity, and applying a threshold measurement to identify related datasets and nodes that are considered similar. High relevance between datasets associated with matched nodes of the lineage graph and nodes of the knowledge graph may indicate a high static rank, i.e., high interestingness. In this manner, embodiments are configured to generate an interestingness score for a dataset associated with a list of matched nodes. Similarly, in this manner, embodiments are configured to generate the interestingness score based on a user query and the mapping the knowledge node of the knowledge graph to a lineage node of a lineage graph. Datasets associated with matched nodes having a high interestingness score may be grouped and identified as ranked dataset recommendations, i.e., datasets most relevant to the words or phrases in a user query and which should be provided as search results to an input search query. In this manner, embodiments are configured to identify a ranked dataset recommendation based on the interestingness score. Similarly, a semantic relevance score for matched nodes and their associated datasets may be determined via the semantic relevance learning engine 220 which may also consider user intent determined via the semantic relevance learning engine 220. User intent may be determined via the semantic relevance learning engine 220 by interpreting words and phrases based on their contextual relevance within a search query. In this manner, embodiments are configured to identify contextual links between the knowledge graph and the lineage graph via the semantic relevance learning engine 220. Contextual links may include knowledge graph concepts including user queries, and lineage graph concepts including user profiles. Contextual links may include knowledge graph concepts including user query interpretation, and lineage graph concepts including users and datasets in a marketplace. The system may produce and communicate a combination of static and dynamic scores, filtered search results, ranked dataset recommendations, and search results by popularity in a user interface. In this manner, embodiments are configured to communicate instructions to communicate the interestingness score and the ranked dataset recommendation in a user interface, such as on a display of a user device. Similarly, embodiments are configured to generate a semantic relevance score for a dataset associated with the list of matched nodes; identify a ranked dataset recommendation based on the semantic relevance score; and communicate instructions to communicate the semantic relevance score and the ranked dataset recommendation in a user interface. In this way, linked nodes and their corresponding datasets may be ranked, and popularity may be quantified, such as by a semantic relevance score and an interestingness score, indicative of the relative textual or temporal similarities or contextual relevance between two nodes on a lineage graph and a knowledge graph. Filtered search results may be arranged from highest to lowest static or semantic relevance score and may be communicated as ranked datasets recommendations and their corresponding static or semantic relevance score.

The RGCN model 218 may be configured to map concepts, entities, events, and their corresponding relationships to generate the knowledge graph by classifying nodes based on concepts, entities, and events and identifying contextual relationships or inferences between nodes. The RGCN model 218 may map, i.e., link, concepts, entities, events, and their corresponding relationships by learning features and characteristics for concepts, entities, and nodes and relations in a graph. The RGCN model 218 may apply graph convolution layers to perform feature extraction and aggregation to learn features and characteristics. The RGCN model 218 may leverage features and characteristics to infer relationships and patterns between concepts, entities, and nodes in a graph. In this manner, embodiments are configured to map an entity to a knowledge node in a knowledge graph. Similarly, in this manner, embodiments are configured to map a knowledge node of a knowledge graph to a lineage node of a lineage graph. The RGCN model may be trained on the lineage graph and the knowledge graph, and the system may perform semantic relevance learning via the semantic relevance learning engine 220 to generate a list of nodes from the lineage graph that are most relevant to the nodes in the knowledge graph, and map the same. The RGCN model may be trained to receive a lineage graph and a knowledge graph as input and based on this input, to output a list of nodes from the lineage graph that are most relevant to the nodes in the knowledge graph. Mapping may include linking the lineage nodes of the lineage graph with knowledge nodes of the knowledge graph from the list of nodes output by the RGCN model, such as via flagging or tagging mapped nodes as linked or paired based on their relevance to each other. In this manner, embodiments are configured to generate a list of matched nodes from the mapping of the knowledge node of the knowledge graph to the lineage node of the lineage graph.

The semantic relevance learning engine 220 may be configured to perform semantic relevance learning including identifying similarities between nodes, such as text-based or temporal similarities, to generate a list of nodes from the lineage graph that are most relevant to the nodes in the knowledge graph using the RGCN model 218 trained on the lineage graph and the knowledge graph.

In embodiments, the query interpreter module 210, knowledge graph module 212, lineage graph module 214, popularity module 216, RGCN model 218, and semantic relevance learning engine 220, each may include modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The popularity search server 240 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

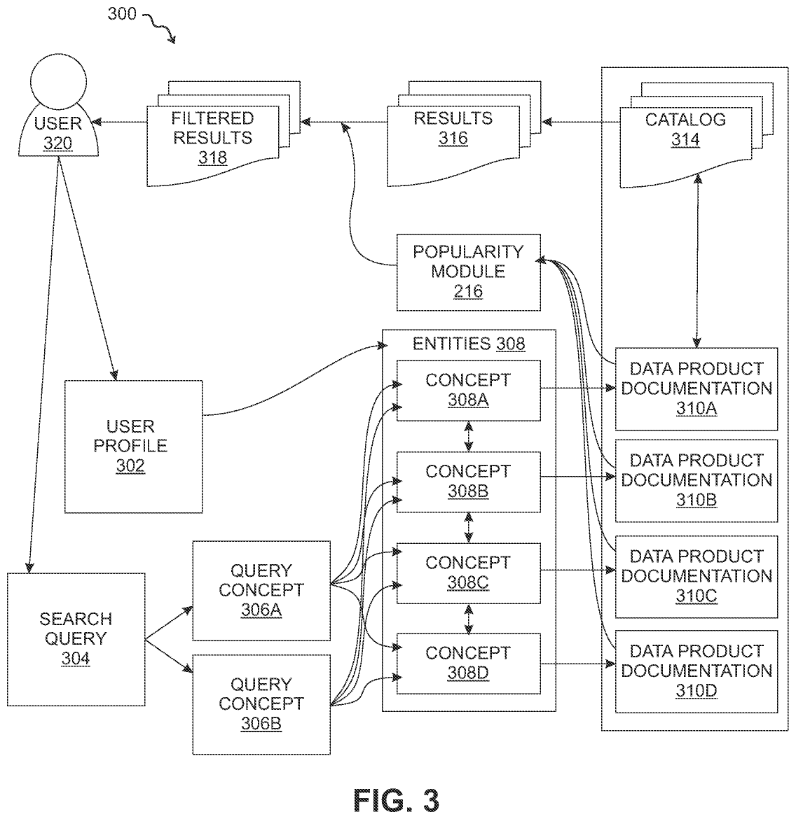

FIG. 3 shows a flowchart of an exemplary system 300 in accordance with aspects of the present invention. Steps of the method may be carried out in the environment of FIG. 2 and are described with reference to elements depicted in FIG. 2. A user 320 may have a user profile 302, such as user information and historical query data. The user 320 may input a search query 304 into the system, including query concepts 306A and 306B. Query concepts 306A and 306B may include, for example, search queries relating to “mortgages” and “contact information” when the user 320 is searching for housing purchase data via search query 304. Search query 304 may be interpreted via the query interpreter module 210 of FIG. 2 to identify entities 308 including concepts 308A, 308B, 308C, and 308D. Concepts 308A, 308B, 308C, and 308D may be nodes of a known or generated knowledge graph adopted by or generated by the knowledge graph module 212 and may be related to query concepts 306A, 306B input by the user 320, or retrieved directly from a user profile 302. For example, query concepts 306A and 306B may be “mortgages” and “contact information” and concepts 308A, 308B, 308C, and 308D may be related entities, such as housing price, buyers, sellers, commercial clients, etc. Concepts 308A, 308B, 308C, and 308D may include relational links, i.e., edges representing relations between nodes of a knowledge graph. The RGCN model 218 of FIG. 2 may predictively link concepts 308A, 308B, 308C, and 308D, entities, events, and their corresponding relationships to data product documentation 310A, 310B, 310C, and 310D of catalog 314 and generate the knowledge graph by classifying nodes based on concepts 308A, 308B, 308C, and 308D, entities, and events and identifying contextual relationships or inferences between nodes. Catalog 314 may be a data catalog including data assets therein. The system may retrieve results 316 relating to the search query 304 through catalog 314, including traditionally retrieved search results, as well as filtered results 318 generated by the popularity module 216. The popularity module 216 may be configured to generate an interestingness measure, i.e., ranking, for datasets in a data marketplace, such as catalog 314, with respect to a search query 304, in order to create filtered results 318 based on the ranking. The RGCN model 218 of FIG. 2 may be trained on the lineage graph generated via the lineage graph module 214 and the knowledge graph adopted by or generated by the knowledge graph module 212, and the system may perform semantic relevance learning via the semantic relevance learning engine 220 of FIG. 2 to map lineage nodes from the lineage graph that are most relevant to the knowledge nodes in the knowledge graph, and generate a list recommending the overlapping nodes as recommendations including filtered search results 318. The system may produce and communicate to user 320, such as on a computing device display, a combination of static and dynamic scores, filtered search results 318, dataset recommendations, and search results by popularity.

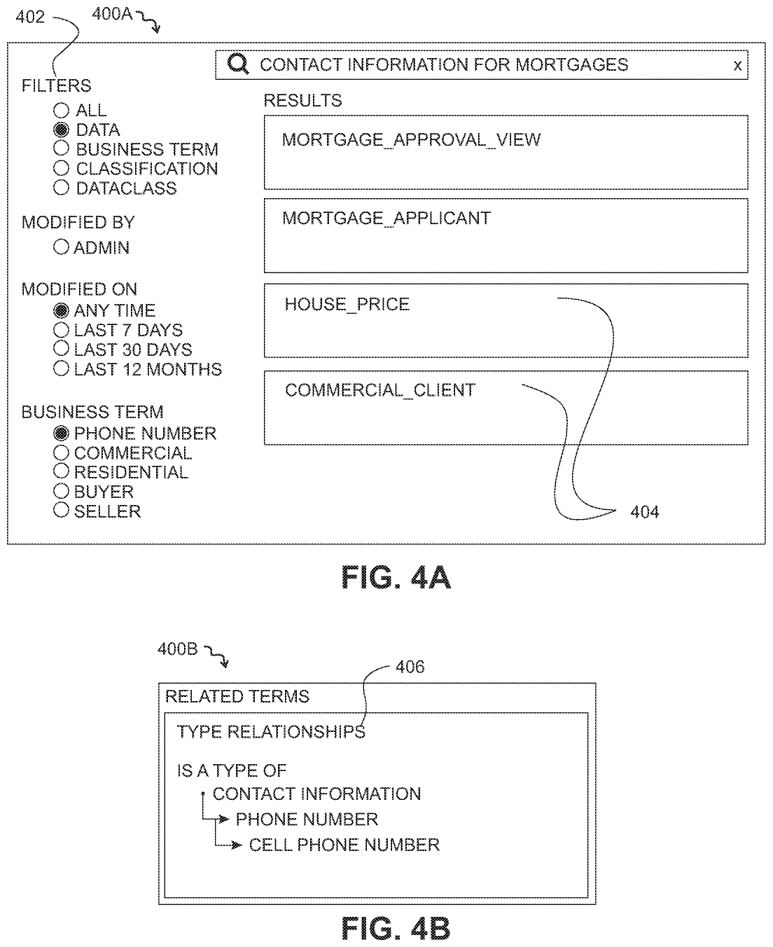

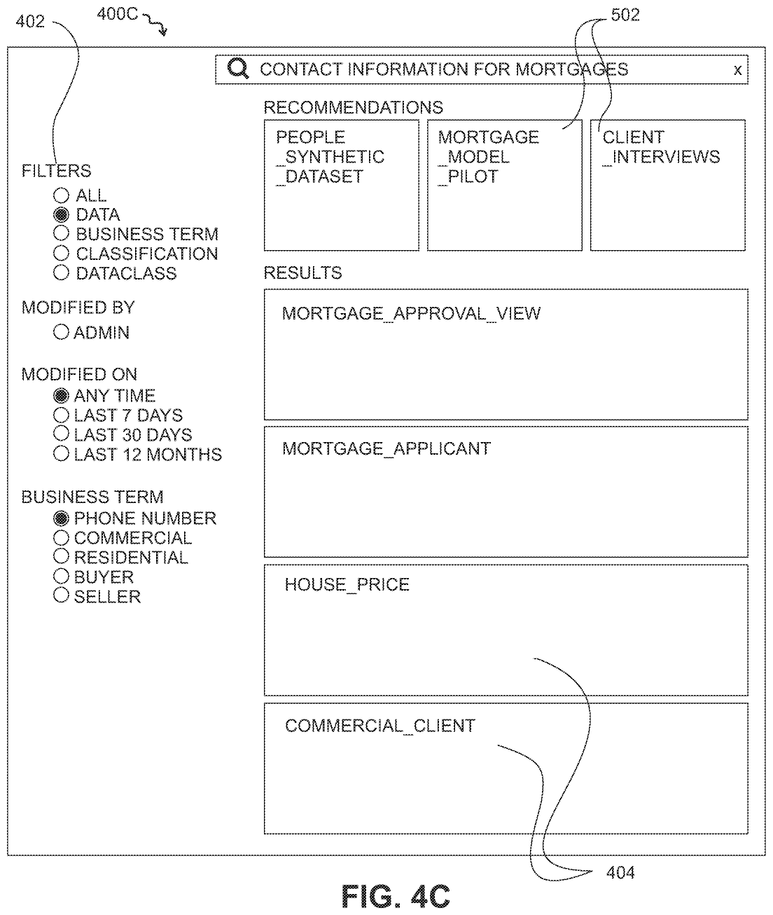

FIG. 4A shows an exemplary user interface 400A according to an embodiment of the present invention, including search filters 402 and search results 404 generated according to the system 300 depicted in FIG. 3. Search results 404 may be retrieved from data product documentation 310A, 310B, 310C, and 310D of catalog 314 of FIG. 3 and may communicated on a user device.

FIG. 4B shows an exemplary user interface 400B according to an embodiment of the present invention, including type relationships 406 corresponding to predictively linked concepts, entities, events, and their corresponding relationships identified by RGCN model 218 of FIG. 2.

FIG. 4C shows an exemplary user interface 400C according to an embodiment of the present invention, including search filters 402 and search results 404 generated according to the system 300 depicted in FIG. 3. Search results 404 may be retrieved from data product documentation 310A, 310B, 310C, and 310D of catalog 314 of FIG. 3 and may communicated on a user device. Recommendations 502 may be generated based on semantic relevance learning between concepts in the knowledge graph and user information in the lineage graph. Recommendations 502, correlating to filtered results 318 of FIG. 3, may be generated and ranked by the popularity module 216 of FIG. 2 and FIG. 3.

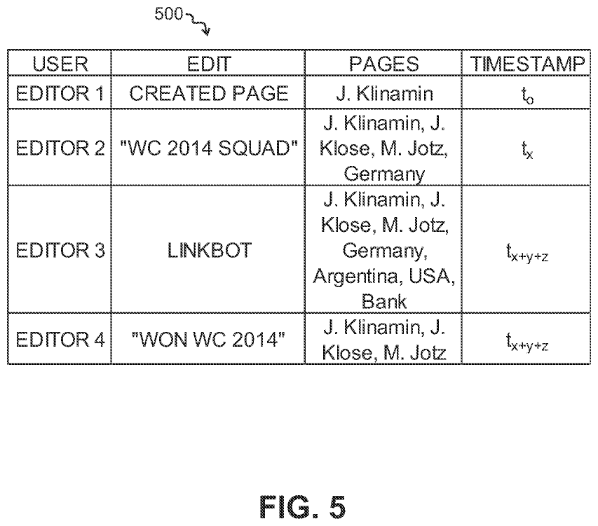

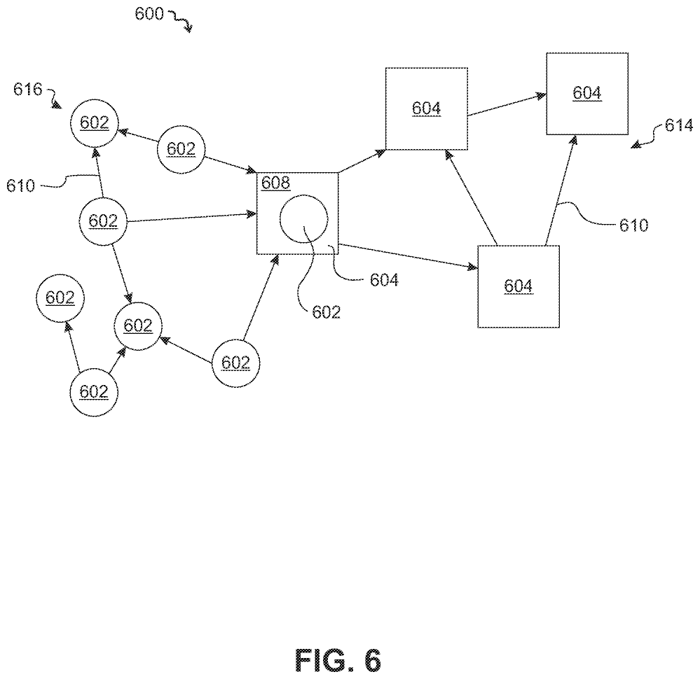

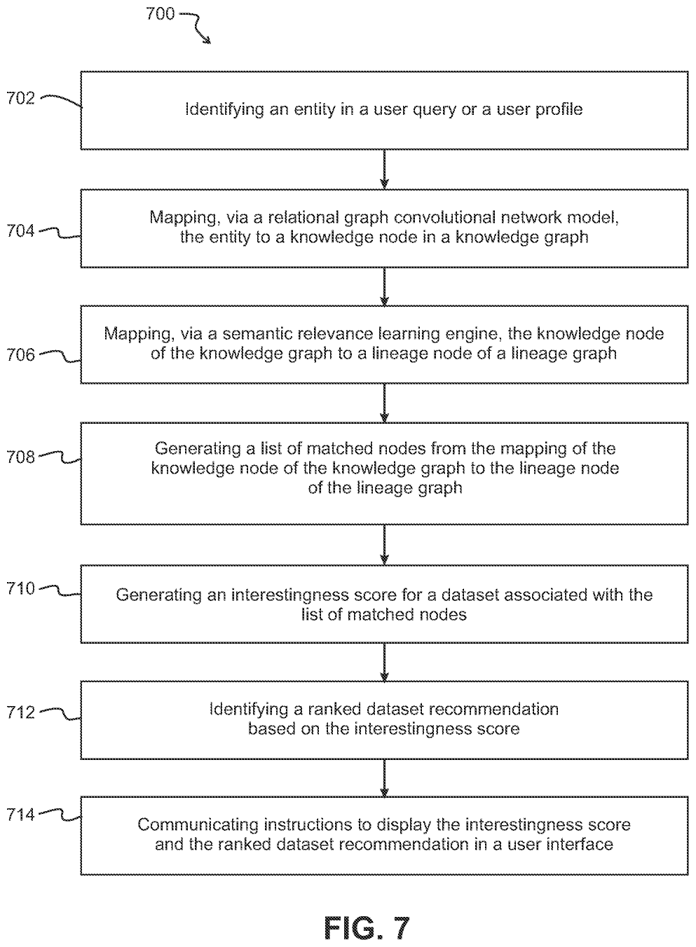

FIG. 5 shows an exemplary table 500 according to an embodiment of the present invention depicting a non-limiting example of how a lineage graph may be generated via the lineage graph module 214 of FIG. 2 having nodes of clustered data indicating time-stamped events of when users edited particular documentation. In this example, users may have made multiple edits to various documents or datasets at different times, recorded as timestamps. It may be desirable to identify which users have made multiple edits within a recent timeframe while excluding users who have made edits infrequently during the same timeframe. The disclosed system may link users and pages that have been edited more than once within the timeframe, and the linked users and pages may be clustered via DHP. A lineage graph may be generated of linked users and pages which may be used to index further datasets via the lineage graph module 214 of FIG. 2. In the example depicted in FIG. 5, users “EDITOR 2” and “EDITOR 4” may be linked to one another due to similar edits (“WC 2014”) made to similar pages (“J. Klinamin, J. Klose, M. Jotz”). In this way, the system may identify contextual links between datasets, knowledge graphs and lineage graphs. FIG. 6 shows a block diagram of an exemplary environment 600 in accordance with aspects of the present invention. Environment 600 depicts a knowledge graph 616 having knowledge nodes 602 mapped to a lineage graph 614 having lineage nodes 604. Overlapping nodes 608 may include knowledge nodes 602 mapped to lineage nodes 604. The RGCN model 218 of FIG. 2 may be trained on the lineage graph 614, and the knowledge graph 616, and the system may perform semantic relevance learning via the semantic relevance learning engine 220 of FIG. 2 to map the lineage nodes 604 from the lineage graph 614 that are most relevant to the knowledge nodes 602 in the knowledge graph 616, and generate a list recommending the overlapping nodes 608 as recommendations 502 of FIG. 2. Additionally, the semantic relevance learning engine 220 may be configured to identify contextual links 610 between the knowledge graph 616 and the lineage graph 614. Semantic relevance learning may include training a machine learning model, i.e., the semantic relevance learning engine 220, to interpret and assess textual data, including words, phrases, or entire documents, in order to understand the meaning of the textual data so that relevance between textual data may be identified. Semantic relevance learning may include natural language processing of knowledge graph 616 data and lineage graph 614 data. This may include identifying concepts in the knowledge graph and user information in the lineage graph that are relevant to one another. Semantic relevance learning may further include linking lineage nodes of the lineage graph with knowledge nodes of the knowledge graph such as via flagging or tagging mapped nodes as linked or paired. FIG. 7 shows a flowchart 700 of an exemplary method in accordance with aspects of the present invention. In step 702, a computer-implemented method may include identifying an entity in a user query or a user profile via the query interpreter module 210 of FIG. 2. Step 704 may include mapping, via a relational graph convolutional network model such as the RGCN model 218 of FIG. 2, the entity to a knowledge node in a knowledge graph. Step 706 may include mapping, via a semantic relevance learning engine such as the semantic relevance learning module 220 of FIG. 2, the knowledge node of the knowledge graph to a lineage node of a lineage graph. Step 708 may include generating, via the RGCN model 218 of FIG. 2, generating a list of matched nodes from the mapping of the knowledge node of the knowledge graph to the lineage node of the lineage graph. Step 710 may include generating an interestingness score for a dataset associated with the list of matched nodes via the popularity module 216 of FIG. 2. Step 712 may include identifying a ranked dataset recommendation based on the interestingness score via the semantic relevance learning engine 220 of FIG. 2. Step 714 may include communicating instructions to communicate the interestingness score and the ranked dataset recommendation in a user interface via the popularity search server 240 of FIG. 2.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying, by a processor set, an entity in a user query or a user profile;
mapping, by the processor set via a relational graph convolutional network model, the entity to a knowledge node in a knowledge graph;
mapping, by the processor set via a semantic relevance learning engine, the knowledge node of the knowledge graph to a lineage node of a lineage graph;
generating, by the processor set, a list of matched nodes from the mapping of the knowledge node of the knowledge graph to the lineage node of the lineage graph;
generating, by the processor set, an interestingness score for a dataset associated with the list of matched nodes;
identifying, by the processor set, a ranked dataset recommendation based on the interestingness score; and
communicating, by the processor set, instructions to communicate the interestingness score and the ranked dataset recommendation in a user interface.

2. The computer-implemented method of claim 1, further comprising generating the lineage graph based on the user profile, user access details in a marketplace, and a historical query.

3. The computer-implemented method of claim 2, wherein the generating the lineage graph comprises clustering the user profile and the historical query via Dirichlet-Hawkes processing (DHP).

4. The computer-implemented method of claim 3, wherein the clustering comprises generating textual clusters, temporal clusters, or both.

5. The computer-implemented method of claim 2, wherein the generating the lineage graph comprises clustering the user profile, the user access details in a data marketplace, and the historical query.

6. The computer-implemented method of claim 1, wherein the semantic relevance learning engine is configured to identify contextual links between the knowledge graph and the lineage graph.

7. The computer-implemented method of claim 6, wherein the contextual links comprise knowledge graph nodes including user queries, and lineage graph nodes including user profiles.

8. The computer-implemented method of claim 6, wherein the contextual links comprise knowledge graph nodes including user query interpretation, and lineage graph nodes including users and datasets in a marketplace.

9. The computer-implemented method of claim 1, further comprising:
generating a semantic relevance score for the dataset associated with the list of matched nodes;
identifying the ranked dataset recommendation based on the semantic relevance score; and
communicating instructions to communicate the semantic relevance score and the ranked dataset recommendation in a user interface.

10. The computer-implemented method of claim 1, wherein the generating the interestingness score is based on the user query and the mapping the knowledge node of the knowledge graph to a lineage node of a lineage graph.

11. A computer program product comprising one or more computer readable storage media having program instructions collectively stored on the one or more computer readable storage media, the program instructions executable to:
identify an entity in a user query or a user profile;
map the entity to a knowledge node in a knowledge graph;
map, via a semantic relevance learning engine, the knowledge node of the knowledge graph to a lineage node of a lineage graph;
generate a list of matched nodes from the mapping of the knowledge node of the knowledge graph to the lineage node of the lineage graph;
generate an interestingness score for a dataset associated with the list of matched nodes;
identify a ranked dataset recommendation based on the interestingness score; and
communicate instructions to communicate the interestingness score and the ranked dataset recommendation in a user interface.

12. The computer program product of claim 11, wherein the program instructions are executable to: generate the lineage graph based on the user profile, user access details in a marketplace, and a historical query.

13. The computer program product of claim 12, wherein the generating the lineage graph comprises clustering the user profile and the historical query via Dirichlet-Hawkes processing (DHP).

14. The computer program product of claim 13, wherein the clustering comprises generating textual clusters, temporal clusters, or both.

15. The computer program product of claim 12, wherein the generating the lineage graph comprises clustering the user profile, the user access details in a data marketplace, and the historical query via DHP.

16. The computer program product of claim 11, wherein the semantic relevance learning engine is configured to identify contextual links between the knowledge graph and the lineage graph.

17. The computer program product of claim 16, wherein the contextual links comprise knowledge graph nodes including user queries, and lineage graph nodes including user profiles.

18. The computer program product of claim 16, wherein the contextual links comprise knowledge graph nodes including user query interpretation, and lineage graph nodes including users and datasets in a marketplace.

19. The computer program product of claim 11, wherein the program instructions are executable to:
generate a semantic relevance score for the dataset associated with the list of matched nodes;
identify the ranked dataset recommendation based on the semantic relevance score; and
communicate instructions to communicate the semantic relevance score and the ranked dataset recommendation in a user interface.

20. A system comprising:
a processor set, one or more computer readable storage media, and program instructions collectively stored on the one or more computer readable storage media, the program instructions executable to:
identify an entity in a user query or a user profile;
map the entity to a knowledge node in a knowledge graph;
map the knowledge node of the knowledge graph to a lineage node of a lineage graph;
generate a list of matched nodes from the mapping of the knowledge node of the knowledge graph to the lineage node of the lineage graph;
generate an interestingness score for a dataset associated with the list of matched nodes;
identify a ranked dataset recommendation based on the interestingness score; and
communicate instructions to communicate the interestingness score and the ranked dataset recommendation in a user interface.
